(19) United States
(12) Patent Application Publication
(10) Pub. No.: US 2021/0069762 A1
(43) Pub. Date: Mar. 11, 2021

(54) METHOD AND SYSTEM FOR STORING AND PROCESSING SOLID HOUSEHOLD WASTE

(71) Applicant: Vova Melikovich DUMIKYAN, Moscow (RU)

(72) Inventor: Vova Melikovich DUMIKYAN, Moscow (RU)

(21) Appl. No.: 16/642,565

(22) PCT Filed: Aug. 20, 2018
(86) PCT No.: PCT/RU2018/000547

§ 371 Date: Feb. 27, 2020

(30) Foreign Application Priority Data
Sep. 14, 2017 (RU) 2017132150

(51) Int. Cl. B09B 1/00

(52) U.S. Cl. CPC B09B 1/006; B09B 1/004

(57) ABSTRACT

The necessary dimensions are determined for a tank which comprises a pit for the storage and processing of solid household waste of organic origin while taking into account soil characteristics. The bottom of the pit and the side walls thereof are made of poured concrete, the concrete layer undergoes hydrolysis, and the bottom of the tank is made with a slope, wherein at the low point of the bottom of the tank, a water intake for collecting filtrate and water is installed, which is connected by a pump to a water purification filter. Along the perimeter of the tank, a pipe system for discharging biogas is installed which is connected to a biogas purification device. A portion of the solid household waste is loaded into the tank, covered with a water-impermeable material and covered over by a layer of soil.

### CROSS-REFERENCE TO RELATED APPLICATIONS

The present patent application is a National stage application for the PCT application PCT/RU2018/000547 filed Aug. 20, 2018, which claims priority to Russian patent application RU2017132150 filed Sep. 14, 2017, all of which are incorporated herein by reference by their entirety.

### TECHNICAL FIELD

The invention relates to the field of housing and communal services. It can be used for underground storage of solid household waste of organic origin, with the possibility of multiple use of one tank for storage and processing of several such lots of waste.

With the growth of the population, consumption, and the development of industry, the amount of waste also increases, the collection and recycling of which increasingly raises questions in modern society. Different types of waste (pesticides in liquid form and in the form of powders; solid household waste; waste from sewers, etc.) require different storage and processing technologies. For storage of solid household waste of organic origin and other environmentally friendly waste, underground tanks are being increasingly used, which not only save living space, but also receive various processing products (biogas, non-potable water, etc.), which can be used further in the national economy.

### BACKGROUND OF THE INVENTION

There is a method of storing solid and water-saturated waste (RF patent No. 2235610, publ. Sep. 10, 2004), including the analysis of topological conditions and the choice of territory for storage, the development of a pit with the construction of a protective screen and a drainage base along its bottom and sides, followed by a breakdown of the pit into separate sections by dividing strips, each dividing strip being formed by alternating layers of solid waste and drainage waste with the distribution of large fractions of the latter to its side slopes and at the same time carried out on gases from the outlet of each drainage layer through the perforated pipes are connected to pipes installed at the bottom of the slopes. To implement this method, the solid household waste tank is used, which is a recess, on the sides of which a waterproof screen is laid. The drainage base consists of a sand-gravel mixture or crushed stone, which has a connection with the catchment wells in the lower part of the tank with its subsequent removal. There are also gas outlets connected to a common gas collector.

This invention improves environmental safety when storing waste of various origins and their disposal, and also provides the ability to use exhaust gases in the national economy. However, this invention has the following disadvantages: the considered tank design is planned on for the disposal of one batch of loaded waste and does not provide for its reuse for the purpose of storage and processing of several lots of waste; the considered method does not provide for the processing of the first loaded portion of the waste and the release of the tank in order to load, store and process the next batch of waste.

There is a method of storing solid waste at landfills (http://dopoln.ru/pravo/202889/index.html?page=28, viewed Sep. 8, 2017), the most commonly used at present and taken as the closest analogue to the claimed method, which consists in the development of a foundation pit, its bottom is equipped with an anti-filtration screen made of clay and other waterproof layers (bitumen soil, latex) to prevent the filtrate from getting into groundwater,

load the waste into the pit, cover it with material and soil layers from above and gradually compact it with rollers, collect the filtrate using drainage pipes and discharge it to the neutralization tank, biogas is removed by using several rows of vertical wells or horizontal trenches. To implement this method, a solid household waste storage tank is used, which is taken as the closest analogue to the tank included in the inventive system for the storage and processing of solid household waste, which is a foundation pit with an anti-filter screen installed on the bottom, the pit has drainage pipes for collecting leachate, several rows of vertical wells or horizontal trenches for collecting biogas, which are filled with sand or gravel and perforated pipes.

The considered method of storage of solid household waste and the tank are also intended only for storage and decontamination of solid household waste and do not provide for the processing of solid household waste and reuse of the same tank for storage and processing of several lots of waste.

### SUMMARY

The technical result of the present invention is the provision of multiple use of one tank for storage and processing of solid household waste of organic origin due to its implementation from reinforced concrete, as well as ensuring the safety of further use of decayed waste after removing it from the tank.

The technical result is achieved by using the method of storage and processing of solid household waste of organic origin, which consists in designing the tank for the storage and processing of solid household waste of organic origin, taking into account the characteristics of the soil, the required dimensions of the pit of the tank, proximity to the city limits, conduct the construction of this tank, for which the bottom of the pit and its side walls are poured with concrete to obtain a reinforced concrete structure, the concrete layer is waterproofed, the bottom of the tank is sloped. A water inlet is installed at the bottom of the bottom of the tank to collect the filtrate and water, which is connected to the filter for water purification by the pump. A piping system is installed around the tank perimeter for connecting biogas, which is connected to the cleaning device biogas from moisture and condensate removal and a biogas storage tank. Then part of the solid household waste of organic origin is loaded into the tank, cover them with a waterproof material and fill them with a layer of soil from above. After that, repeat the indicated stages of loading part of the waste and closing it until the tank is filled. During operation the forming filtrate and rain water are pumped out of the water intake with a pump for subsequent processing, the resulting biogas through the piping system for biogas withdrawal. It is transferred to a device for processing and purifying biogas from water and removing condensate with a view to its further use. At the same time, the formation of biogas is monitored and, when it is completely stopped, a laboratory analysis of decayed waste in the tank is carried out to confirm the absence of hazardous and harmful substances in it, after which the tank is opened, the waste removed and processed for future use.

Waterproofing of the concrete layer of the bottom and the side walls of the tank can be made bilateral: from the outside—from the ground/ground, from the inside—from the side of the loaded debris. Waterproofing is necessary to prevent the ingress of leachate and harmful substances into the ground, as well as to increase the service life of the concrete layer of a reusable tank. Waterproofing is necessary to prevent the ingress of leachate and harmful substances into the ground, as well as to increase the service life of the concrete layer of a reusable tank. Waterproofing can be obtained by applying two layers of bitumen mastic to the concrete surface.

As a waterproof material, which covers part of the loaded solid household waste of organic origin, use geotextiles and similar materials.

When closing part of solid household waste of organic origin, a layer of sand can be laid first, on which waterproof material and a layer of soil are laid further.

As the first and second protective nets, for example, the well-known building mesh is used.

Biogas can be pumped out of the piping system if necessary using a pump.

The technical result is also achieved by using a system for storage and processing of solid household waste of organic origin, which contains a tank for storage and processing of solid household waste of organic origin, which is a pit, the side walls and the bottom of which are covered with concrete made with waterproofing. The bottom of the tank has a slope. At the bottom of the bottom of the tank there is a water intake for collecting the filtrate and water, connected by means of a pump to a filter for water purification. Around the perimeter of the tank there is a piping system of a mesh structure for removing biogas connected to a device for cleaning biogas from moisture and removing condensate and a device for storing biogas too. Wherein the mesh structure of the piping system is formed by a lower predominantly horizontal pipe extending in the lower part of the tank, an upper predominantly horizontal pipeline extending at the upper edge of the tank, and predominantly vertical pipelines located between said upper and lower pipelines. Moreover, mainly vertical pipelines have drainage sections covered with a first protective net and a second protective net with a layer of crushed stone located between them.

Drainage areas on predominantly vertical pipelines can be positioned so that the waterproof material and soil layer that covers part of the municipal solid household waste of organic origin passes at or above the top of the specified drainage areas.

The implementation of the tank with a reinforced concrete bottom and side walls and waterproofing allows you to use one tank for a long time. Running the bottom of the tank at a slope allows you to collect the filtrate and water in one place—the water intake, from where the liquid can be removed without problems. The presence of a mesh structure of pipelines that completely covers the perimeter of the tank, the presence of drainage areas covered with the first and second protective nets with a layer of crushed stone between them, allows for the complete collection of biogas from the entire volume of the tank and its preliminary purification from the filtrate with harmful substances before it arrives into a device specially designed for this purpose for cleaning biogas from moisture and removing condensate.

Thus, the collection rate of biogas and the quality of its purification are increased. The rapid removal of biogas (gas generated during hydrogen or methane fermentation of biomass) reduces the likelihood of an explosive situation inside the tank, and also contributes to faster decay of the loaded batch of waste with a safe mass suitable for further use in the national economy.

Laying solid household waste of organic origin in the tank in parts, separation of adjacent parts of the waste using a waterproof material and a layer of soil allows you to split the entire tank into parts, each of which is an effective collection of biogas. The introduction of stages for monitoring biogas evolution, monitoring the cessation of its formation, conducting laboratory analysis of decayed waste to determine their safety for future use allows the use of decayed waste for the national economy, and the tank can be reused for storage and processing of the next batch solid household waste of organic waste.

### BRIEF DESCRIPTION OF THE DRAWINGS

In FIG. 1 shows the design of the tank (side view),

FIG. 2—the design of the tank (top view),

FIG. 3 is a general view of the piping system;

FIG. 4—connection of the piping system with a device for cleaning biogas from moisture and removing condensate, a water inlet and a filter for cleaning,

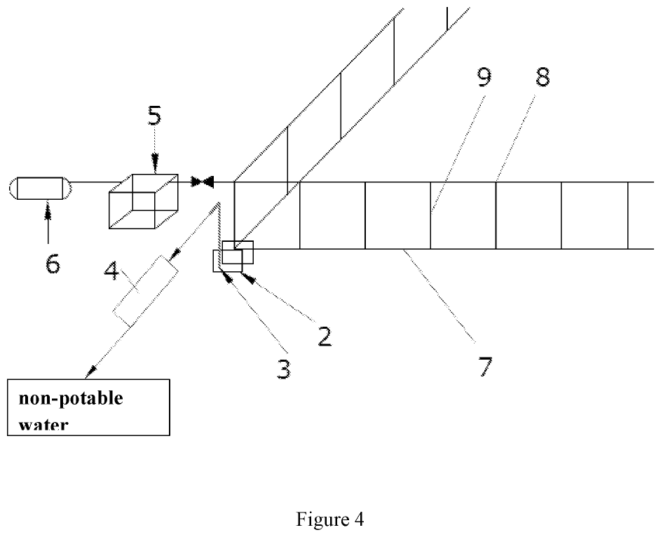

FIG. 5 is an enlarged view of a predominantly vertical pipeline with protective nets.

### DETAILED DESCRIPTION OF THE PREFERRED EMBODIMENT

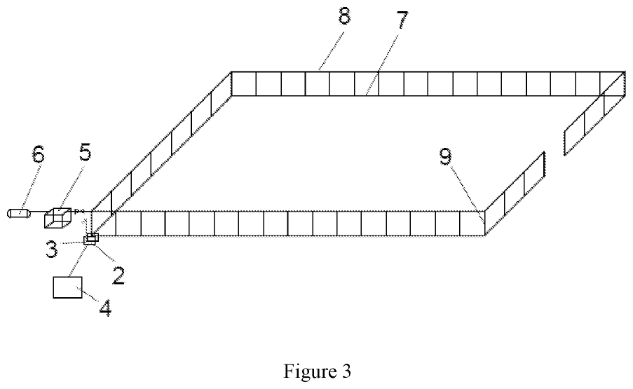

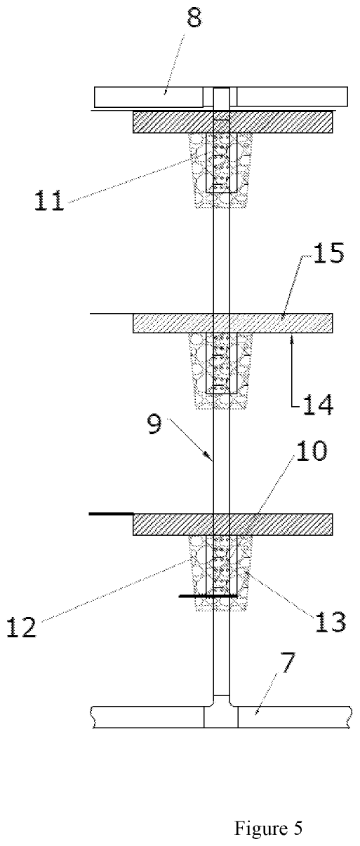

The system for storage and processing of solid household waste of organic origin contains a tank 1 for storage and processing of solid household waste of organic origin, which is a pit, the side walls and the bottom of which are covered with concrete made with waterproofing, the bottom of the tank 1 has a slope of 3-5%, at the bottom of the bottom of the tank 1, a water inlet 2 is installed for collecting the filtrate and water, connected by means of a pump 3 to a filter for water purification 4. Around the perimeter of the tank 1 there is a piping system of a mesh structure for removing biogas connected to a device for cleaning biogas 5 from moisture and removing condensate and a device for storing biogas 6 (FIG. 3, 4). The mesh structure of the piping system is formed by a lower 7 predominantly horizontal pipe extending in the lower part of the tank 1, an upper 8 predominantly horizontal pipeline extending at the upper edge of the tank 1, and mainly vertical pipelines 9 located between said upper 8 and lower 7 pipelines. Moreover, the predominantly vertical pipelines 9 have drainage sections 10 covered with a first protective net 11 and a second protective net 12 with a layer of crushed stone 13 located between them (FIG. 5). Drainage sections 10 on predominantly vertical pipelines 9 can be positioned so that the waterproof material 14 and the soil layer 15, which cover part of the solid household waste of organic origin, passed at or above the top of the indicated drainage sections 10.

The drainage section 10 of the predominantly vertical pipe 9 is a section with holes, for example, with a diameter of 25 mm and a pitch of 50 mm.

The tank 1 can have different sizes and, accordingly, can accommodate a different volume of loaded waste. The tank 1 can have straight or inclined side walls. Also, depending on the friability of the soil, the bottom of the tank 1 can have a slope that is symmetrical on both sides. And it can be made with a slope of the bottom in one direction.

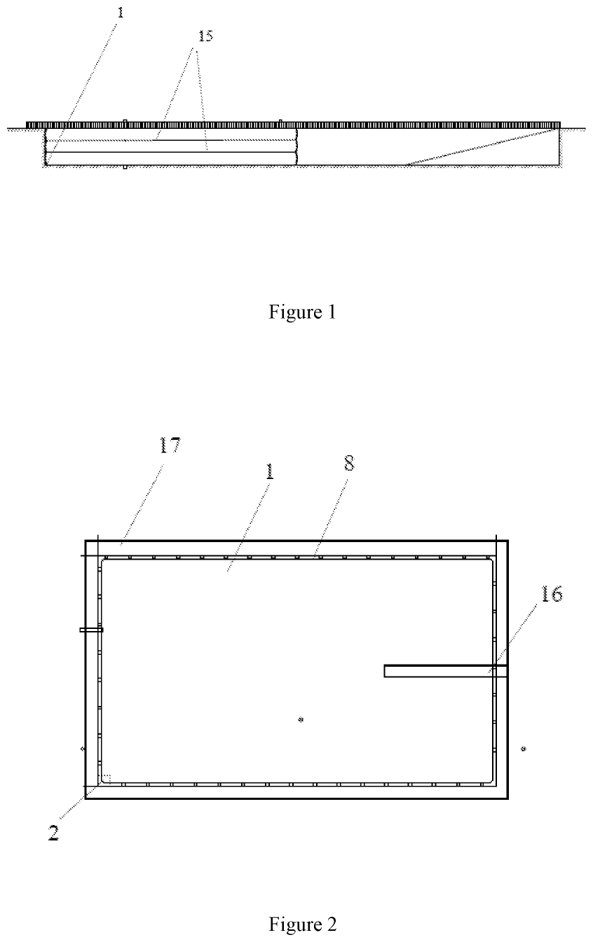

The tank 1 can have a site for the arrival of freight transport 16, different fences, ramps, etc. A service area 17 of tank 1 can also be allocated (FIG. 2).

To begin with, a design of the tank for the storage and processing of solid household waste of organic origin is carried out, for which they take into account the friability of the soil, the required dimensions of the pit of the tank, and proximity to the city limits. Then you dig a foundation pit of the required size. For example, a foundation pit of 150×30×15 m, 200×50×20 m, 300×80×15 m, 300×80×30 m, etc. can be dug. As a result, the volume of the tank can be up to 30 million cubic meters and more. Its bottom and side walls are covered concrete with waterproofing. The bottom of the tank is performed with a slope of 3-5% in one direction or symmetrical on both sides. At the lower point of the bottom of the tank, a water inlet is installed to collect the filtrate and water, which is connected to the filter to purify water through a pump. Then, part of the solid household waste of organic origin is loaded into the tank—for example, waste with a height of 9 is loaded into a 30 m high tank. Then they are covered with waterproof material and covered with a layer of soil up to 1 m high. Then repeat the indicated stages of loading part of the waste and closing it two more times until the tank is completely filled. First, sand with a height of 5-10 cm can be poured over a layer of solid household waste of organic origin, then waterproof material is laid, and then a sand layer with a height of 90-95 cm is poured. On the lower part of the tank (closer to its bottom) lay the lower mainly horizontal pipeline. Mostly vertical pipelines are installed to the height that is approximately equal to the height of falling asleep of the part of solid household waste.

At the same time, drainage sections with first and second protective nets and crushed stone between them are made on the upper part of predominantly vertical pipelines. Upon reaching the upper edge of the tank, an upper, mainly horizontal pipe is laid, which is connected to a device for cleaning biogas from moisture and removing condensate and a tank for storing biogas. When the solid household waste of organic origin is decayed, a filtrate is formed, which flows into the water intake and is pumped out by pumps. Biogas is also formed, which from each layer of waste enters through drainage sections into a piping system with a mesh structure. Moreover, during operation, the formation of biogas is constantly monitored and, when it is completely discontinued, a laboratory analysis of decayed waste in the tank is carried out to confirm the absence of hazardous and harmful substances in it. After that, the tank is opened, the waste removed and processed for further use in the national economy. The empty tank is ready for loading a new batch of solid household waste of organic origin.

The claimed method of storage and processing of solid household waste of organic origin and a system for its implementation allows you to reuse a concrete tank for storing waste and obtaining safe decayed mass from it, which can be used further for the national economy. For example, as fertilizer. At the same time, the process of waste decaying is accelerated, which gives additional advantages—biogas comes in a purer and sufficient amount, which allows you to quickly fill the biogas storage device and use it for its intended purpose. The multiple use of one pit for processing several batches of waste significantly reduces the need for the construction of pits for the disposal of one batch of waste, which saves time and money for design, construction and operation.

What is claimed is:

1. A method of storage and processing of a solid household waste of organic origin, comprising in designing a tank for storage and processing of the solid household waste of organic origin, taking into account characteristics of a soil, required dimensions of a pit for the tank, proximity to city limits;
then carrying out a construction of the specified tank, for which a bottom of the pit and its side walls are poured with concrete to obtain a reinforced concrete structure, waterproofing an obtained concrete layer, the bottom of the pit is made with a slope;
installing a water inlet at the bottom of the tank to collect a filtrate and water, which is connected via a pump to a filter for water purification;
installing a piping system along a perimeter of the tank to remove biogas, which is connected to a device for cleaning biogas from moisture and removing condensate and also to a biogas storage tank;
loading a part of the solid household waste of organic origin into the tank, closing with a waterproof material and covering with a layer of soil;
repeating indicated stages of loading parts of the waste and closing it until the tank is full;
Afterwards, the resulting filtrate and rainwater are pumped out with a pump for subsequent processing;
the resulting biogas is transferred through the piping system for biogas removal to a device for processing and purifying biogas from water and removing condensate for its further use;
at the same time, a formation of biogas is monitored and, when it is completely stopped, a laboratory analysis of a decayed waste in the tank is carried out to confirm an absence of hazardous and harmful substances;
then the tank is opened, the waste is removed and processed for future use.

2. A system for storage and processing of solid household waste of organic origin, comprising a tank for storage and processing of solid household waste of organic origin, which is a pit, side walls and a bottom of which are covered with a waterproof concrete; the bottom of the tank has a slope; at a lower point of the bottom of the tank there is a water inlet for collecting to filtrate and water, connected by means of a pump to a filter for water purification; around a perimeter of the tank there is a piping system of a mesh structure for removing biogas connected to a device for cleaning biogas from moisture and removing condensate and also to a device for storing biogas; wherein the mesh structure of the piping system is formed by a lower predominantly horizontal pipe extending in the lower part of the tank, an upper predominantly horizontal pipeline extending at an upper edge of the tank, and predominantly vertical pipelines located between said upper and lower pipelines; and mainly vertical pipelines have drainage sections covered with a first protective net and a second protective net with a layer of crushed stone located between them.
